(19) United States
(12) Patent Application Publication
(10) Pub. No.: US 2023/0189101 A1
(43) Pub. Date: Jun. 15, 2023

(54) Methods and Apparatus for Change of Connection Link Involving Sidelink Relays

(71) Applicant: Huawei Technologies Co., Ltd., Shenzhen (CN)

(72) Inventor: Hao Bi, Lake Zurich, IL (US)

(21) Appl. No.: 18/164,254

(22) Filed: Feb. 3, 2023

Related U.S. Application Data
(63) Continuation of application No. PCT/US2021/044546, filed on Aug. 4, 2021.
(60) Provisional application No. 63/061,525, filed on Aug. 5, 2020.

(51) Int. Cl. H04W 36/00; H04W 36/08

(52) U.S. Cl. CPC H04W 36/03; H04W 36/08; H04W 88/04

(57) ABSTRACT

A method implemented by a user equipment (UE) includes sending, by the UE to a source access node, a message including a relay UE information report comprising information associated with at least one UE detectable by the UE; participating, by the UE with the source access node, in a handover initiation; detaching, by the UE, from the source access node; synchronizing, by the UE with the at least one UE, the at least one UE operating as a relay UE for communication between the UE and a target access node over a sidelink connection; and participating, by the UE with the at least one UE, in a handover completion.

### CROSS-REFERENCE TO RELATED APPLICATIONS

This application is a continuation of International Application No. PCT/US2021/044546, filed on Aug. 4, 2021, entitled “Methods and Apparatus for Change of Connection Link Involving Sidelink Relays,” which claims the benefit of U.S. Provisional Application No. 63/061,525, filed on Aug. 5, 2020, entitled “Methods and Apparatus for Sidelink Relay Path Switch,” applications of which are hereby incorporated herein by reference in their entireties.

### TECHNICAL FIELD

The present disclosure relates generally to methods and apparatus for digital communications, and, in particular embodiments, to methods and apparatus for change of connection link involving sidelink relays.

### BACKGROUND

In general, a user equipment (UE) can be in direct communication with a radio access network (RAN). The UE may also be in sidelink communication with another UE. If the UE is out of coverage of the RAN, the UE cannot communicate with the RAN. However, a UE that is in direct communication with the RAN can serve as a relay UE for the UE that is out of coverage of the RAN. In other words, the relay UE allows the UE to have indirect communication with the RAN, with the relay UE serving as intermediary between the UE and the RAN. The relay UE in this situation is referred to as a sidelink relay.

However, a UE that is in direct communication may move outside of coverage of the RAN and lose coverage of the RAN. Furthermore, a UE that is in indirect communication with the RAN may move outside of the range of the relay UE and lose connection with the relay UE. Therefore, there is a need for methods and apparatus for change of connection link involving sidelink relays. As used herein, a change of connection link may also be referred to as a path switch.

### SUMMARY

An advantage of a preferred embodiment is that a change of connection link involving a relay UE is supported to maintain the connection of a UE to the network as the UE moves in and out of coverage of an access node or a relay UE. Maintaining the connection of the UE helps to improve the overall user experience.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a first example communications system;

FIG. 2 illustrates a communication system highlighting handovers involving relay UEs;

FIG. 3 illustrates a diagram highlighting processing performed and communication exchanged by entities participating in an indirect to direct handover involving relay UEs;

FIGS. 4A and 4B illustrate a diagram highlighting processing performed and communication exchanged by entities participating in a direct to indirect handover involving relay UEs according to example embodiments presented herein;

FIG. 5 illustrates a diagram highlighting processing performed and communication exchanged by entities participating in an indirect to direct handover involving Layer-₃ relay UEs according to example embodiments presented herein;

FIG. 6 illustrates a diagram highlighting processing performed and communication exchanged by entities participating in a direct to indirect handover involving Layer-₃ relay UEs according to example embodiments presented herein;

FIG. 7 illustrates a flow diagram of example operations occurring in a UE participating in a direct to indirect handover involving relay UEs according to example embodiments presented herein;

FIG. 8 illustrates a flow diagram of example operations occurring in a source access node participating in a direct to indirect handover involving relay UEs according to example embodiments presented herein;

FIG. 9 illustrates a flow diagram of example operations occurring in a UE participating in a direct to indirect handover involving Layer-₃ relay UEs according to example embodiments presented herein;

FIG. 10 illustrates a flow diagram of example operations occurring in a source access node participating in a direct to indirect handover involving Layer-₃ relay UEs according to example embodiments presented herein;

FIG. 11 illustrates a flow diagram of example operations occurring in a relay UE participating in a direct to indirect handover involving Layer-₃ relay UEs according to example embodiments presented herein;

FIG. 12 illustrates a flow diagram of example operations occurring in a UE participating in an indirect to direct handover involving relay UEs according to example embodiments presented herein;

FIG. 13 illustrates a flow diagram of example operations occurring in a source access node participating in an indirect to direct handover involving relay UEs according to example embodiments presented herein;

FIG. 14 illustrates a flow diagram of example operations occurring in a target access node participating in an indirect to direct handover involving relay UEs according to example embodiments presented herein;

FIG. 15 illustrates a flow diagram of example operations occurring in a relay UE participating in an indirect to direct handover involving relay UEs according to example embodiments presented herein;

FIG. 16 illustrates a flow diagram of example operations occurring in a relay UE participating in a direct to indirect handover involving relay UEs according to example embodiments presented herein;

FIG. 17 illustrates a flow diagram of example operations occurring in a target access node according to example embodiments presented herein;

FIG. 18 illustrates a flow diagram of example operations occurring in a communications device as a remote UE according to example embodiments presented herein;

FIG. 19 illustrates a flow diagram of example operations occurring in a communications device as a relay UE according to example embodiments presented herein;

FIG. 20 illustrates a flow diagram of example operations occurring in a communications device as target access node according to example embodiments presented herein;

FIG. 21 illustrates an example communication system according to example embodiments presented herein;

FIGS. 22A and 22B illustrate example devices that may implement the methods and teachings according to this disclosure;

FIG. 23 is a block diagram of a computing system that may be used for implementing the devices and methods disclosed herein;

FIG. 24 illustrates a block diagram of an embodiment processing system for performing methods described herein, which may be installed in a host device; and

FIG. 25 illustrates a block diagram of a transceiver adapted to transmit and receive signaling over a telecommunications network according to example embodiments presented herein.

### DETAILED DESCRIPTION OF ILLUSTRATIVE EMBODIMENTS

The structure and use of disclosed embodiments are discussed in detail below. It should be appreciated, however, that the present disclosure provides many applicable concepts that can be embodied in a wide variety of specific contexts. The specific embodiments discussed are merely illustrative of specific structure and use of embodiments, and do not limit the scope of the disclosure.

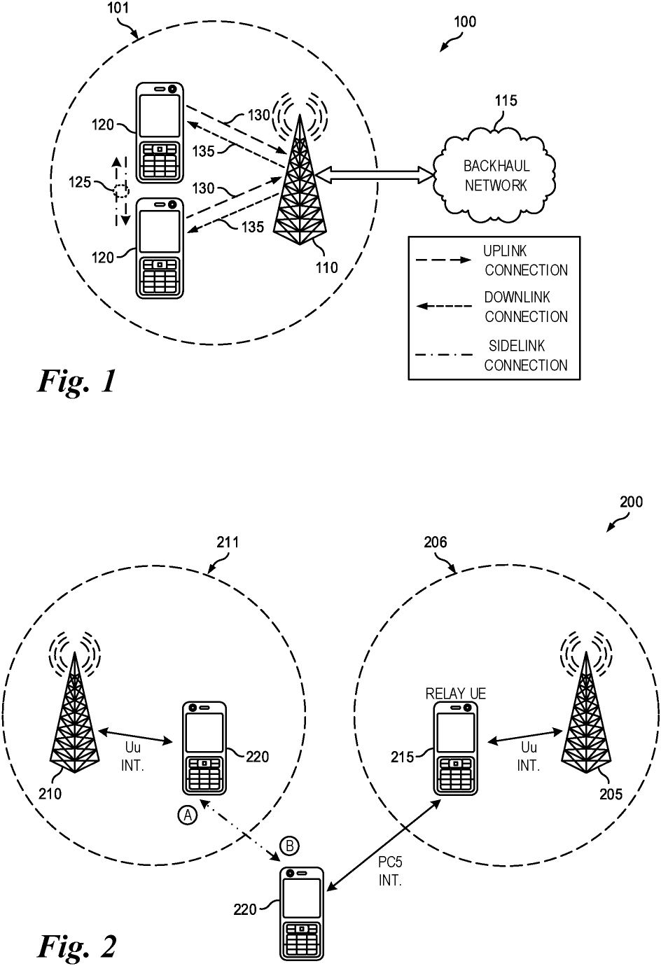

FIG. 1 illustrates a first example communications system 100. Communications system 100 includes an access node 110, with coverage area 101, serving user equipments (UEs), such as UEs 120. Access node 110 is connected to a backhaul network 115 that provides connectivity to services and the Internet. In a first operating mode, communications to and from a UE passes through access node 110. In a second operating mode, communications to and from a UE do not pass through access node 110, however, access node 110 typically allocates resources used by the UE to communicate when specific conditions are met. Communication between a UE pair in the second operating mode occurs over sidelinks 125, comprising device-to-device or peer-to-peer communication links. Communication between a UE and access node pair also occur over uni-directional communication links, where the communication links between the UE and the access node are referred to as uplinks 130, and the communication links between the access node and UE is referred to as downlinks 135.

Access nodes may also be commonly referred to as Node Bs, evolved Node Bs (eNBs), next generation (NG) Node Bs (gNBs), master or primary eNBs (MeNBs), secondary eNBs (SeNBs), master or primary gNBs (MgNBs), secondary gNBs (SgNBs), network controllers, control nodes, base stations, access points, transmission points (TPs), transmission-reception points (TRPs), cells, carriers, macro cells, femtocells, pico cells, and so on, while UEs may also be commonly referred to as mobile stations, mobiles, terminals, users, subscribers, stations, and the like. Access nodes may provide wireless access in accordance with one or more wireless communication protocols, e.g., the Third Generation Partnership Project (₃GPP) long term evolution (LTE), LTE advanced (LTE-A), ₅G, ₅G LTE, ₅G NR, sixth generation (6G), High Speed Packet Access (HSPA), the IEEE 802.11 family of standards, such as 802.11a/b/g/n/ac/ad/ax/ay/be, etc. While it is understood that communications systems may employ multiple access nodes capable of communicating with a number of UEs, only one access node and two UEs are illustrated for simplicity.

In general, a UE can be in direct communication with a radio access network (RAN), through an access node, for example. The UE may also be in sidelink communication with another UE. If the UE is out of coverage of the RAN, the UE cannot communicate with the RAN. A UE that is in direct communication with the RAN can serve as a relay UE for the UE that is out of coverage of the RAN. The relay UE allows the UE to have indirect communication with the RAN.

However, a UE that is in direct communication with the RAN may move outside of coverage of the RAN and lose coverage with the RAN. Furthermore, a UE that is in indirect communication with the RAN may move outside of range of the relay UE and lose connection with the relay UE. Therefore, there is a need for methods and apparatus that support a change of connection link (or similarly a path switch) between a UE and a relay UE or a UE and a RAN to provide service continuity.

FIG. 2 illustrates a communication system 200 highlighting change of connection link involving relay UEs. Communication system 200 includes a first access node 205 with coverage 206 and a second access node 210 with coverage 211. First access node 205 is serving a first UE 215, while second access node 210 is serving a second UE 220. As shown in FIG. 2, second UE 220 is mobile and over time, second UE 220 moves from position A to position B. At position B, second UE is outside of the coverage of second access node 210.

As second UE 220 moves from position A to position B, it’s the quality of the channel between second UE 220 and second access node 210 will tend to drop. Eventually, the quality drops below a threshold and the connection between second UE 220 and second access node 210 is broken. However, as second UE 220 moves away from second access node 210, second UE 220 notices that the signal quality is dropping and may initiate a change of connection link to maintain communication to network.

As shown in FIG. 2, second UE 220 detects first UE 215. Because first UE 215 is capable of operating as a relay UE and amenable to serve second UE 220, second UE 220 is able to handover to first UE 215 and indirectly obtaining service from first access node 205.

The handover process discussed above is a direct to indirect handover and may also be referred to as a direct to indirect path switch.

In an alternative situation, second UE 220 is initially located at position B and is obtaining indirect service from first access node 205 through first UE 215 operating as a relay UE. As second UE 220 moves from position B to position A, second UE 220 enters the coverage of second access node 210. Hence second UE 220 detects the presence of second access node 210, by measurement of signals transmitted by second access node 210, for example. Furthermore, second UE 220 is moving away from first UE 215. Therefore, the quality of the indirect connection to first access node 205 drops.

To prevent service loss, second UE 220 performs a handover to second access node 210 and directly obtains service from second access node 210. This process is referred to as an indirect to direct handover (or an indirect to direct path switch).

Mobility without service interruption is one of the most important features of cellular communication. Service continuity involving UE to network relay consists of two basic scenarios from the point of view of the remote UE:
A path switch from indirect communication with an access node through a relay UE using a PC₅ interface to direct communication to the same or different access node using an Uu interface; and
Conversely, a path switch from direct communication with an access node using a Uu interface to indirect communication with the same or different access node through a relay UE using a PC₅ interface.

According to an example embodiment, methods and apparatus for change of connection link involving sidelink relays are provided. The methods and apparatus support a UE handover from a direct connection to a source access node to an indirect connection to a target access node through a relay UE. The methods and apparatus also support a UE handover from an indirect connection to a source access node through a relay UE to a direct connection to a target access node. The source access node and the target access node may be the same access node or different access nodes.

In an embodiment, in an indirect to direct handover, the remote UE detaches from the relay UE and synchronizes to the target access node (or a target cell of the target access node), with RRC messages being exchanged between the remote UE and the source access node occurs over the relay UE.

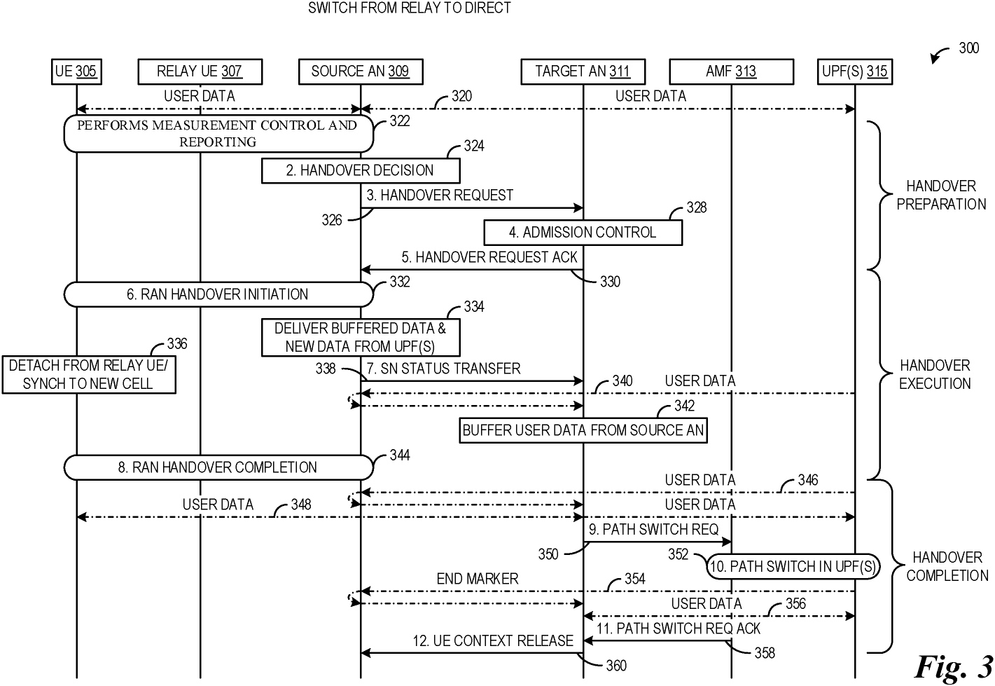

FIG. 3 illustrates a diagram 300 highlighting processing performed and communication exchanged by entities participating in an indirect to direct handover involving relay UEs. The entities participating in the indirect to direct handover include a remote UE 305, a relay UE 307, a source access node 309, a target access node 311, an AMF 313, and a UPF 315.

Initially, user data from remote UE 305 is sent to source access node 309 through relay UE 307, where it is sent to UPF 315 (shown as dashed line 320). Similarly, user data from UPF 315 is sent to source access node 309 and then relayed to remote UE 305 by relay UE 307. However, as remote UE 305 moves, the connection with relay UE 307 may deteriorate. Alternatively, relay UE 307 may no longer be able to operate as a relay UE for remote UE 305. As an example, relay UE 307 may move away from remote UE 305 or source access node 309.

Remote UE 305 and source access node 307 performs measurement control and reporting (block 322). Measurement control and reporting may be used to determine handoff connections in a network with consideration being given to connection quality and quality of service (QoS) restrictions and requirements. As an example, remote UE 305 may provide its measurement report of channel conditions to source access node 309, and source access node 309 may determine if the existing connection is sufficient to meet the QoS restrictions and requirements of remote UE 305.

Source access node 309 makes a handover decision (block 324). Source access node 309 makes the handover decision based on the QoS restrictions and requirements of remote UE 305, as well as its own available resources, and the quality and capability of the existing connection. If source access node 309 determines that a handover is needed, the source access node 309 selects one or more target access nodes (including target access node 311) and sends a handover request to the one or more target access nodes (event 326). The handover request may include the QoS restrictions and requirements of remote UE 305, as well as identifying information associated with remote UE 305, for example.

Target access node 311, upon receiving the handover request, performs admission control (block 328). Target access node 311 determines if it can support the QoS restrictions and requirements of remote UE 305 and sends a handover request acknowledgement back to source access node 309 (event 330). The handover request acknowledgement may indicate to source access node 309 that target access node 311 is amenable to establishing a connection with remote UE 305. The handover request acknowledgement may also include identifying information of the remote UE 305 and its configuration of MAC/RLC/PDCP/SDAP entities and DRBs associated with target access node 311, for example.

Remote UE 305 and source access node 309 participate in handover initiation (block 332). Handover initiation may include messages exchanged to start the handover process. Source access node 309 also delivers buffered data (along with newly received data from UPF 315) to remote UE 305 (block 334). Remote UE 305 detaches from relay UE 307 and synchronizes to the new cell of target access node 311 (block 336). Detaching from relay UE 307 means that remote UE 305 is no longer capable of receiving data from source access node 309 through relay UE 307.

Source access node 309 performs a sequence number status transfer (event 338). The sequence number status transfer is performed with target access node 311 and informs target access node 311 the sequence number of the last packet successfully transmitted to remote UE 305. The transfer of the sequence number helps to ensure that the user data of remote UE 305 are not lost or unnecessarily retransmitted. At this point, user data intended for remote UE 305 may still be transmitted to source access node 309. However, this user data is forwarded to target access node 311 (shown as dashed line 340). Target access node 311 buffers the user data received from source access node 309 (block 342).

Remote UE 305 and source access node 309 complete handover (block 344). With the handover complete, user data intended for remote UE 305 continues to be sent to source access node 309, which transfers the user data to target access node 311 (shown as dashed line 346). User data from remote UE 305 is sent directly to target access node 311, which transfers the user data to UPF 315 (shown as dashed line 348).

Target access node 311 sends a path switch request (event 350). The path switch request is sent to AMF 313, for example, and informs the network that target access node 311 is now the access node for remote UE 305 and that source access node 309 is no longer the access node for remote UE 305. AMF 313 and UPF 315 perform a path switch (block 352). The path switch changes the path for remote UE 305 from source access node 309 to target access node 311. An end marker is sent to source access node 309 to indicate to source access node 309 to no longer expect further user data for remote UE 305. Source access node 309 transfers the end marker to target access node 311 (shown as dashed line 354). Subsequent data for remote UE 305 is sent to target access node 311 (shown as dashed line 356).

AMF 313 sends a path switch request acknowledgement (event 358). The path switch request acknowledgement is sent to target access node 311. The path switch request acknowledgement indicates to target access node 311 that the path switch is complete, for example. Target access node 311 sends a UE context release (event 360). The UE context release is sent to source access node 309. The source access node 309 releases the UE context of remote UE 305, along with resources allocated to remote UE 305 (e.g., buffer space, processing resources, etc.). The source access node 309 sends RRC reconfiguration signaling to the relay UE 307, and changes or removes configurations of RLC channel over PC₅ interface (the interface between remote UE 305 and relay UE 307) and Uu interface (the interface between relay UE 307 and target access node 311), and mappings of the remote UE 305 between RLC channels of Uu interface and RLC channels of PC₅ interface.

In an embodiment, in a direct to indirect handover, the remote UE detaches from the source access node (or a source cell of the source access node) and synchronizes to the relay UE, with RRC messages being directly exchanged between the remote UE and the source access node.

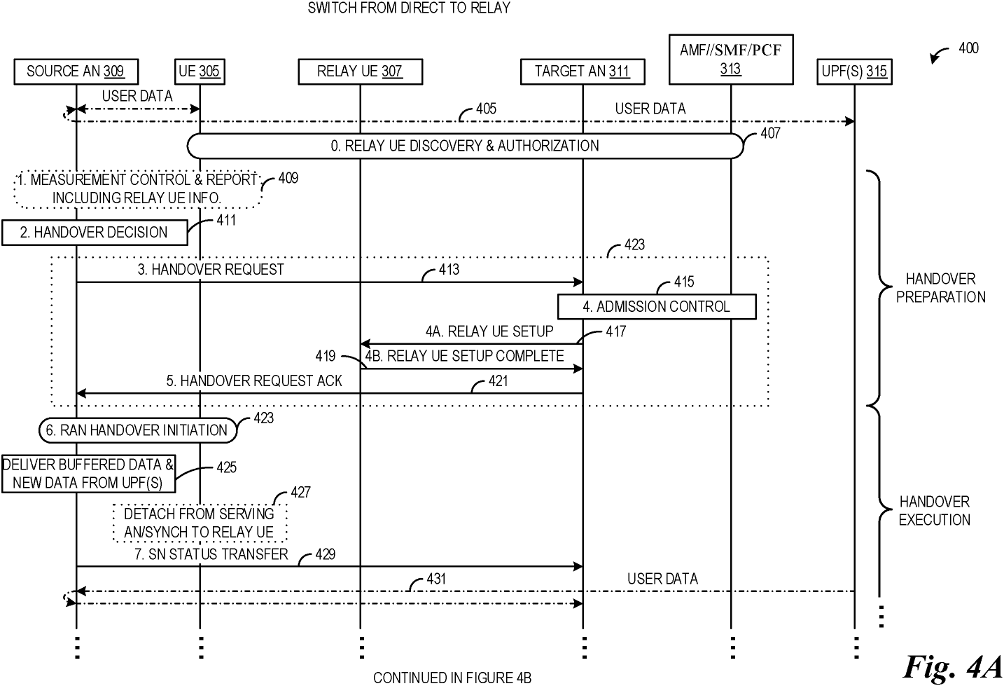

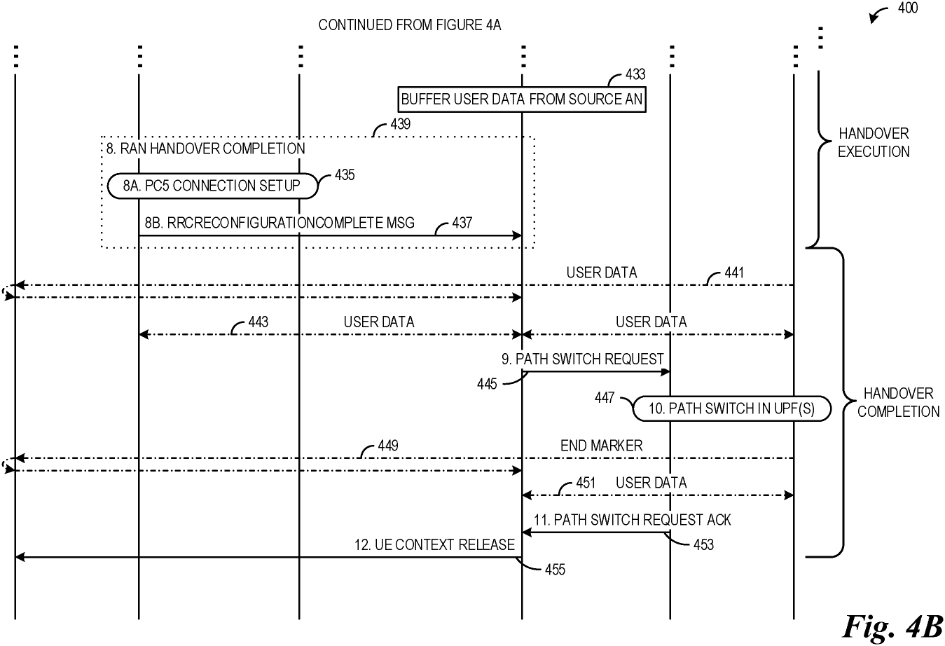

FIGS. 4A and 4B illustrate a diagram 400 highlighting processing performed and communication exchanged by entities participating in a direct to indirect handover involving relay UEs. The entities participating in the direct to indirect handover include a source access node 309, a remote UE 305, a relay UE 307, a target access node 311, an AMF 313, and a UPF 315.

Initially, user data from remote UE 305 is sent directly to source access node 309, where it is sent to UPF 315 (shown as dashed line 405). Similarly, user data from UPF 315 is sent to source access node 309 and then to remote UE 305. However, as remote UE 305 moves, the connection with source access node 309 may deteriorate.

Remote UE 305 and AMF 313 participate in relay UE discovery and authorization (block 407). Relay UE discovery and authorization may include remote UE 305 making measurements of transmissions made by UEs operating in the vicinity, for example. Transmissions of UEs that meet a specified signal quality or signal strength threshold may indicate that these UEs may be suitable candidate relay UEs. Remote UE 305 may provide identification information for these UEs to AMF 313, which may then perform authorization to determine which of these UEs can serve as relay UEs for remote UE 305.

Remote UE 305 sends a measurement control and report (block 409). The measurement control and report is sent to source access node 309, for example. The measurement control and report may include information related to UEs that are suitable candidate relay UEs for remote UE 305 that have been authorized to be relay UEs for remote UE 305. As an example, the measurement control and report includes relay UE identity, information related to quality of connection between remote UE 305 and relay UE 307, e.g., the signal or channel condition, the data rate, and its connected cell info, e.g., serving cell and/or access node identity. Source access node 309 makes a handover decision (block 411). The handover decision may be made in accordance with the information reported by remote UE 305 in the measurement control and report, as well as measurements of the connection between remote UE 305 and source access node 309. As an example, source access node 309 may determine that a handover should be performed and select a candidate relay UE to serve as relay UE for remote UE 305.

Source access node 309 sends a handover request (event 413). The handover request is sent to target access node 311, for example, where target access node 311 is identified by information provided by remote UE 305. The handover request may include information related to remote UE 305, as well as information related to relay UE 307 (the candidate relay UE selected by source access node 309). The information may include identifying information. Target access node 311 and AMF 313 perform admission control (block 415). Admission control may be used to determine handoff connections in a network with consideration being given to QoS restrictions and requirements of remote UE 305. Admission control involves consultation with AMF 313 with regard to indirect communication between remote UE 305 and target access node 311 through relay UE 307, for example.

Target access node 311 sends a relay UE setup (event 417). The relay UE setup is sent to relay UE 307, for example, and is used to configure relay UE 307. As an example, the relay UE setup is used to configure a radio link control (RLC) channel over PC₅ interface, and mappings between RLC channels of Uu interface (the interface between relay UE 307 and target access node 311) and RLC channels of PC₅ interface (the interface between remote UE 305 and relay UE 307). Relay UE 307 sends a relay UE setup complete (event 419). The relay UE setup complete is sent to target access node 311, for example, and indicates successful configuration of relay UE 307.

Target access node 311 sends a handover request acknowledgement (event 421). The handover request acknowledgement is sent to source access node 309, for example. The handover request acknowledgement may include a container for remote UE 305 in the handover request acknowledge sent to source access node 309, which contains the configuration for remote UE 305 to synchronize and establish a sidelink connection with relay UE 307, such as relay UE identity, target access node 311 and/or cell identity, and data radio bearer (DRB) configurations, such as for RLC/Packet Data Convergence/Service Data Adaptation Protocols (RLC/PDCP/SDAP) entities, including the mappings of ₅G QoS flows to DRBs. Collectively, events and blocks 413-421 are referred to as handover configuration 423.

The handover is initiated (block 423). The handover is initiated by source access node 309 transmitting a message to remote UE 305. Source access node 309 also delivers buffered data and new data from UPF 315 to remote UE 305 (block 425). Remote UE 305 detaches from source access node 309 and synchronizes to relay UE 307. Detaching from source access node 309 means that remote UE 305 is no longer capable of directly receiving data from source access node 309.

Source access node 309 performs a sequence number status transfer (event 429). The sequence number status transfer is performed with target access node 311 and informs target access node 311 the sequence number of the last packet successfully transmitted to remote UE 305. The transfer of the sequence number helps to ensure that the user data of remote UE 305 are not lost or unnecessarily retransmitted. At this point, user data intended for remote UE 305 may still transmitted to source access node 309. However, this user data is forwarded to target access node 311 (shown as dashed line 431). Target access node 311 buffers the user data received from source access node 309 (block 433).

Remote UE 305 and relay UE 307 perform a PC₅ connection setup (block 435). The PC₅ connection is setup in accordance with configuration information in the container generated by target access node 311 and provided to source access node 309. Remote UE 305 sends a RRC Reconfiguration Complete (event 437). The RRC Reconfiguration Complete is sent to target access node 311, for example. The RRC Reconfiguration Complete completes the switching procedure. Collectively, block 435 and event 437 make up handover execution 439.

At this point, user data intended for remote UE 305 may still be delivered to source access node 309, which transfers the user data to target access node 311 (shown as dashed line 441). However, some user data intended for remote UE 305, as well as user data from remote UE 305, is sent to or from target access node 311 through relay UE 307 (shown as dashed line 443). Target access node 311 sends a path switch request (event 445). The path switch request is sent to AMF 313, for example, and informs the network that target access node 311 is now the access node for remote UE 305 and that source access node 309 is no longer the access node for remote UE 305. AMF 313 and UPF 315 perform a path switch (block 447). The path switch changes the path for remote UE 305 from source access node 309 to target access node 311. An end marker is sent to source access node 309 to indicate to source access node 309 to no longer expect further user data for remote UE 305. Source access node 309 transfers the end marker to target access node 311 (shown as dashed line 449). Subsequent data for remote UE 305 is sent to target access node 311 (shown as dashed line 451).

AMF 313 sends a path switch request acknowledgement (event 453). The path switch request acknowledgement is sent to target access node 311. The path switch request acknowledgement indicates to target access node 311 that the path switch is complete, for example. Target access node 311 sends a UE context release (event 455). The UE context release is sent to source access node 309 and indicates to source access node 309 to release the UE context of remote UE 305, along with resources allocated to remote UE 305 (e.g., buffer space, processing resources, etc.).

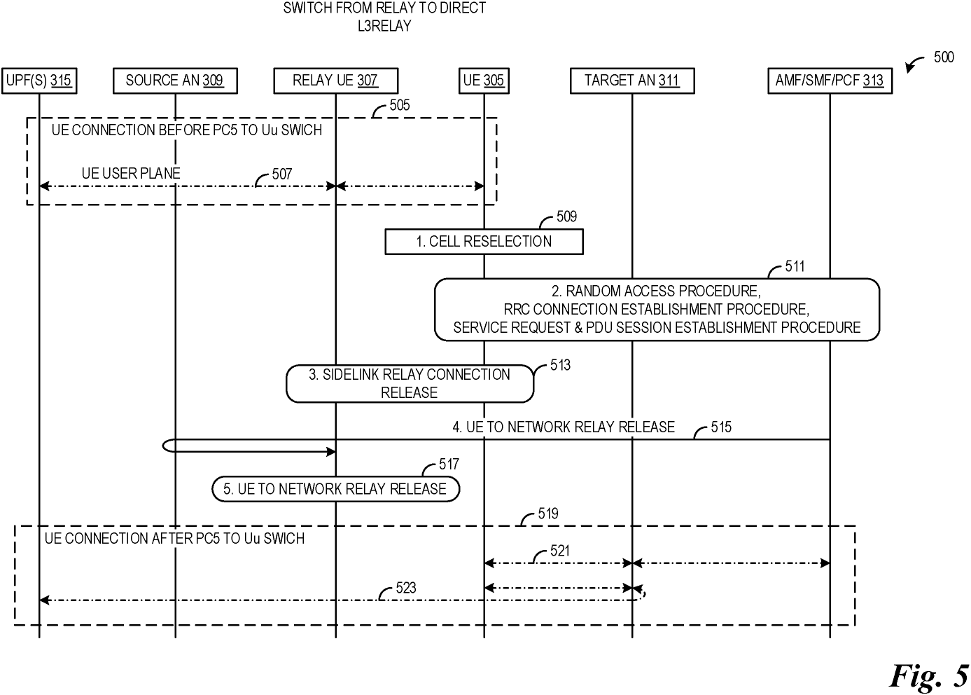

FIG. 5 illustrates a diagram 500 highlighting processing performed and communication exchanged by entities participating in an indirect to direct handover involving Layer-₃ relay UEs. The entities participating in the indirect to direct handover include a remote UE 305, a relay UE 307, a source access node 309, a target access node 311, an AMF 313, and a UPF 315.

Box 505 illustrates the connection of remote UE 305 before the PC₅ to Uu switch. Prior to the PC₅ to Uu switch, user data associated with remote UE 305 are relayed to or from remote UE 305 by relay UE 307 (shown as dashed line 507).

Remote UE 305 performs cell reselection (block 509). Remote UE 305 may perform cell reselection to change cell (or access nodes) after remote UE 305 is attached to the cell. Cell reselection may involve remote UE 305 making channel measurements of cells, access nodes, relay UEs, etc., to determine which has the best radio condition. For discussion purposes, consider the situation where target access node 311 has the best radio condition. Remote UE 305 and AMF 313 perform procedures to establish service with target access node 311 (block 511). The procedures may include a random access procedure, a RRC connection establishment procedure, a service request, and a PDU session establishment procedure. After completion of the procedures to establish RRC connection with target access node 311, remote UE 305 is connected to target access node 311 with a PDU session. The remote UE 305 should also indicate that it has an indirect connection with the network, through a relay UE, and provides the information about the indirect connection, such as the identity information of the relay UE and the source access node 309, the UE identity used in the indirect connection, the IP address/prefix or TCP/UDP port number used in the indirect connection, MAC address used in the indirect connection, PC₅ link identity used in the indirect connection, PDU session identity used in the indirect connection, etc.

Remote UE 305 releases the sidelink relay connection (block 513). Remote UE 305 and relay UE 307 release the RLC channels on sidelink connection for UE to network relay. Remote UE 305 is no longer connected to source access node 309 through relay UE 307. AMF/SMF/PCF 313 sends a UE to network relay release (event 515). The UE to network relay release releases relay UE 307 from serving remote UE 305. The UE to network relay release may be sent to source access node 309, which transfers the UE to network relay release to relay UE 307. The relay UE can be provided with the UE’s information, such as the UE identity used in the indirect connection, the IP address/prefix or TCP/UDP port number used in the indirect connection, MAC address used in the indirect connection, PC₅ link identity used in the indirect connection, PDU session identity used in the indirect connection, etc. Relay UE 307 stops serving remote UE 305 (block 517).

Box 519 illustrates the connection of remote UE 305 after the PC₅ to Uu switch. After the PC₅ to Uu switch, control data associated with remote UE 305 passes through target access node 311 and AMF 313 (shown as dashed line 521) and user data associated with remote UE 305 passes through target access node 311 and UPF 315 (shown as dashed line 523).

FIG. 6 illustrates a diagram 600 highlighting processing performed and communication exchanged by entities participating in a direct to indirect handover involving Layer-₃ relay UEs. The entities participating in the direct to indirect handover include a remote UE 305, a relay UE 307, a source access node 309, a target access node 311, an AMF 313, and a UPF 315.

Box 605 illustrates the connection of remote UE 305 before the Uu to PC₅ switch. Prior to the Uu to PC₅ switch, control plane data associated with remote UE 305 are directly communicated to or from remote UE 305 by source access node 307 to AMF 313 (shown as dashed line 607), while user plane data associated with remote UE 305 are directly communicated to or from remote UE 305 by source access node 307 to UPF 315 (shown as dashed line 609).

Remote UE 305 and AMF 313 participate in relay UE discovery and authorization (block 611). Relay UE discovery and authorization may include remote UE 305 making measurements of transmissions made by UEs operating in the vicinity, for example. Transmissions of UEs that meet a specified signal quality or signal strength threshold may indicate that these UEs may be suitable candidate relay UEs. Remote UE 305 may provide identification information for these UEs to AMF 313, which may then perform authorization to determine which of these UEs can serve as relay UEs for remote UE 305.

Remote UE 305 and relay UE 307 (a relay UE identified in relay UE discovery and authorization, for example) participate in PC₅ RRC connection establishment (block 613). The PC5 RRC connection establishment involves an exchange of RRC messages to establish a connection over PC5 interface. Remote UE 305 sends a UE to network relay setup request (event 615). The UE to network relay setup request is sent to relay UE 307, for example, and may include identifying information of remote UE 305, as well as information about direct connection with the source access node 309, such as the identity of serving cell/gNB, and the UE’s identity in the serving cell/gNB. Relay UE 307 relays the UE to network relay setup request (event 617). The UE to network relay setup request is relayed to target access node 311, for example. The information of UE’s direct connection is also forwarded to the access and mobility management, session management, and policy control functions (AMF/SMF/PCF 313)

Target access node 311 and AMF 313 perform admission control (block 619). The admission control is performed based on information associated with remote UE 305 and relay UE 307. Target access node 311 sends a relay UE setup response to relay UE 307 (event 621). Target access node 311 provides relay UE 307 with a RLC configuration of a DRB over a PC5 interface between remote UE 307 and relay UE 307. Relay UE 307 relays the UE to network relay setup response (event 623). The UE to network relay setup response is relayed to remote UE 305. Relay UE 307 configures RLC entities of the sidelink DRBs.

Remote UE 305 sends UE to network relay setup complete message to relay UE 307 (event 625). After establishing the RLC entities of the sidelink DRBs, remote UE 305 provides confirmation of the establishment to relay UE 307. Remote UE 305 may also update the RLC configuration of the sidelink DRBs. Relay UE 307 sends a remote UE report to AMF/SMF/PCF 313 (event 627). The remote UE report indicates to AMF/SMF/PCF 313 that remote UE 305 is now indirectly connected to target access node 311. AMF 313 sends a PDU session release (event 629). The PDU session release is sent to source access node 309, which also forwards the PDU session release to remote UE 305. The PDU session release causes source access node 309 and remote UE 305 to release the PDU session. Source access node 309 and remote UE 305 also release the RRC connection (block 631). The releasing of the RRC connection results in the releasing of resources dedicated to the RRC session. After the RRC connection release, remote UE 305 and source access node 309 are no longer connected.

Box 633 illustrates the connection of remote UE 305 after the Uu to PC5 switch. After the Uu to PC5 switch, user plane data associated with remote UE 305 are relayed by relay UE 635.

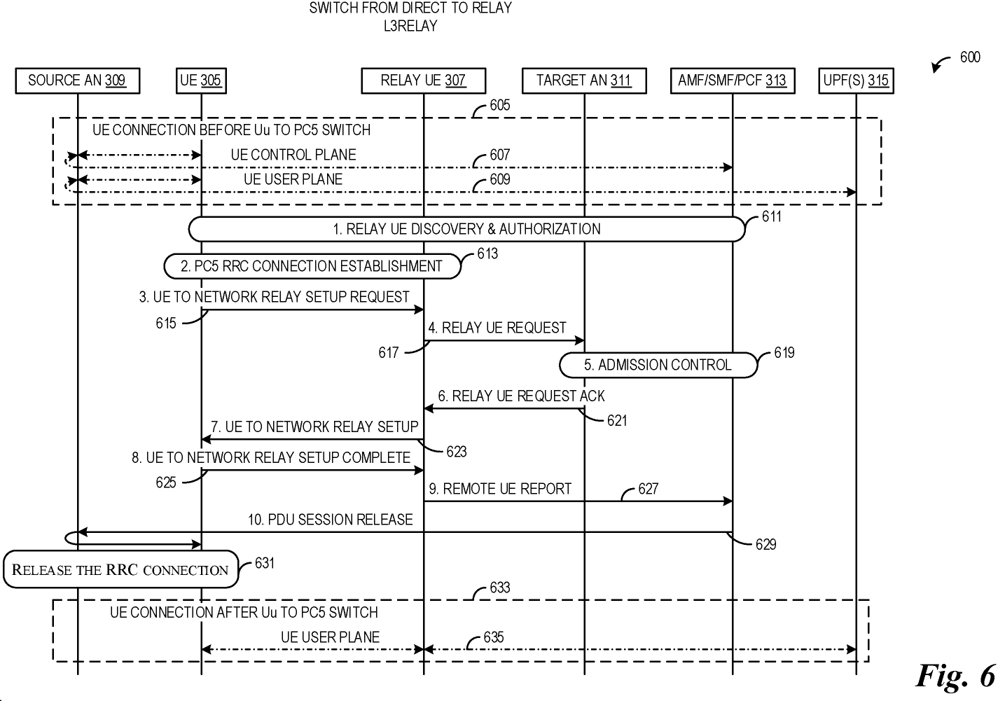

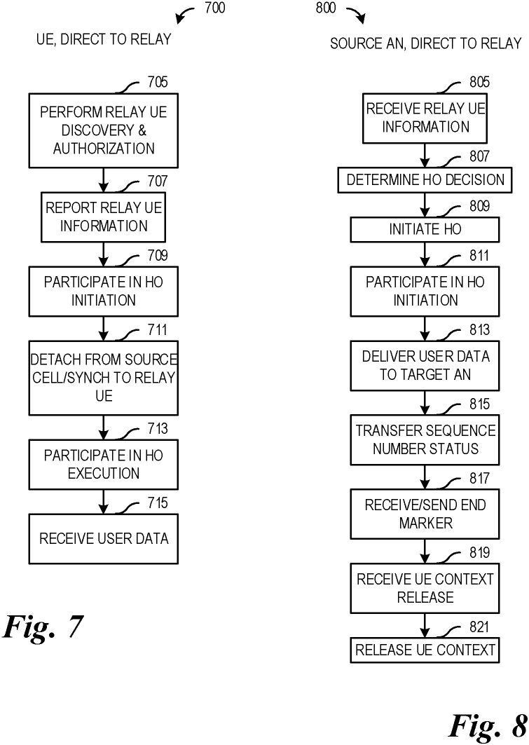

FIG. 7 illustrates a flow diagram of example operations 700 occurring in a UE participating in a direct to indirect handover involving relay UEs.

Operations 700 begin with the UE performing relay UE discovery and authorization (block 705). Relay UE discovery and authorization may include the UE making measurements of transmissions made by UEs operating in the vicinity, for example. Transmissions of UEs that meet a specified signal quality or signal strength threshold may indicate that these UEs may be suitable candidate relay UEs for the UE. The UE reports the relay UE information (block 707). The UE sends a measurement control and report, for example. The measurement control and report may include information related to UEs that are suitable candidate relay UEs for the UE that have been authorized to be relay UEs for the UE. As an example, the measurement control and report includes relay UE identity, information related to quality of connection between the UE and the relay UE, e.g., the signal or channel condition, the data rate, and its connected cell info, e.g., cell and/or access node identity.

The UE participates in handover initiation (block 709). Handover initiation may involve the source access node of the UE sending a message to the UE, the message initiating the handover. The UE detaches from the source cell (e.g., the source access node) and synchronizes to the relay UE (block 711). Detaching from the source access node means that the UE is no longer capable of directly receiving data from the source access node. The UE participates in handover execution (block 713). Handover execution may include the UE participating in the setup of a PC5 connection, as well as sending an indication of completion of the RRC reconfiguration, for example. The UE may begin to receive user data (block 715). The user data is received from the target access node through the relay UE.

FIG. 8 illustrates a flow diagram of example operations 800 occurring in a source access node participating in a direct to indirect handover involving relay UEs.

The source access node receives relay UE information (block 805). The relay UE information is received from the UE in measurement control and report, for example, and may include information related to UEs that are suitable candidate relay UEs for the UE that have been authorized to be relay UEs for the UE. As an example, the measurement control configures the condition under which the UE should start discovering and measuring candidate relay UEs and the frequencies on which candidate relay UE may be discovered. And measurement report includes relay UE identity, information related to quality of connection between the UE and the relay UE, e.g., the signal or channel condition, the data rate, and its connected cell info, e.g., cell and/or access node identity. The source access node determines a handover decision (block 807). The handover decision may be made in accordance with the information reported by the UE in the measurement report, as well as measurements of the connection between the UE and the source access node. As an example, the source access node may determine that a handover should be performed and select a candidate relay UE to serve as relay UE for the UE because the condition of the connection between the UE and the source access node has dropped below a threshold.

The source access node initiates a handover (block 809). The source access node initiates a handover by sending a handover request to the target access node, for example, where the target access node is identified by the information received from the UE. The handover request may include information related to the UE, as well as information related to the relay UE (the relay UE may be selected by the source access node). The information may include identifying information. The source access node participates in the handover initiation (block 811). The source access node transmits a message to the UE to initiate the handover. The source access node delivers user data to the target access node (block 813) and transfers the sequence number status (block 815). The sequence number status transfer is performed with the target access node and informs the target access node the sequence number of the last packet successfully transmitted to the UE by the source access node. The transfer of the sequence number helps to ensure that the user data of the UE are not lost or unnecessarily retransmitted.

The source access node receives an end marker (block 817). The end marker denotes that the source access node has received the last of the user data for the UE. The source access node also sends the end marker to the target access node. The source access node receives a UE context release (block 819). The UE context release is received from the target access node and is an indication to the source access node that it is ok to release the context of the UE. The source access node releases the context of the UE (block 821).

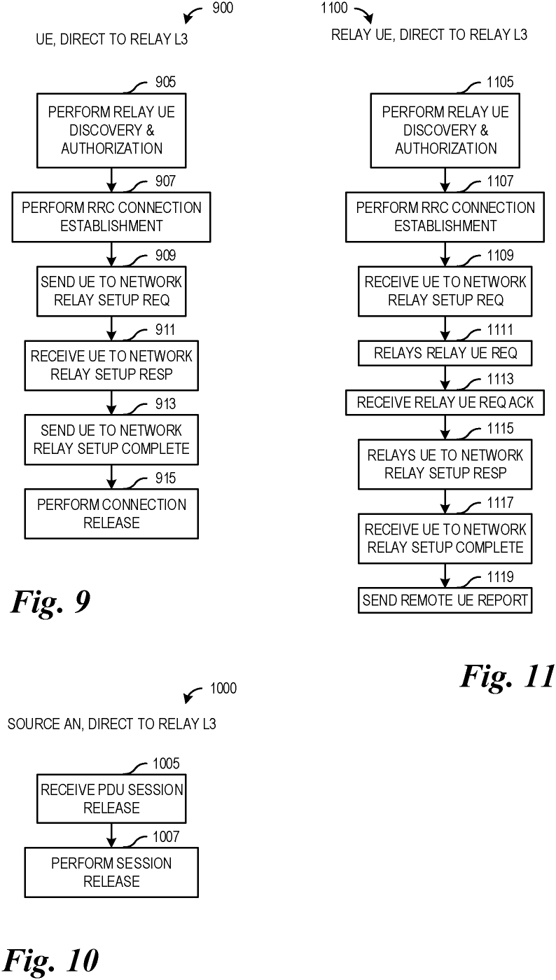

FIG. 9 illustrates a flow diagram of example operations 900 occurring in a UE participating in a direct to indirect handover involving Layer-3 relay UEs.

Operations 900 begin with the UE performing relay UE discovery and authorization (block 905). Relay UE discovery and authorization may include the UE making measurements of transmissions made by UEs operating in the vicinity, for example. Transmissions of UEs that meet a specified signal quality or signal strength threshold may indicate that these UEs may be suitable candidate relay UEs for the UE. The UE performs RRC connection establishment (block 907). The RRC connection establishment process exchanges RRC messages to establish a PC5 connection between the UE and the relay UE.

The UE sends a UE to network relay setup request (block 909). The UE to network relay setup is sent to the relay UE, for example, and initiates the establishment of a relay connection for the UE and the target access node with the relay UE providing relaying operation. The UE provides its identity information, as well as information about direct connection with the source access node 309, such as the identity of serving cell/gNB, and the UE’s identity in the serving cell/gNB. The UE receives a UE to network relay setup response (block 911). The UE to network relay setup response is received from the relay UE and includes configuration information of RLC entities of the sidelink DRBs.

The UE sends UE to network relay setup complete message to the relay UE (block 913). After establishing the RLC entities of the sidelink DRBs, the UE provides confirmation of the establishment to the relay UE. The UE may also update the RLC configuration of the sidelink DRBs. The UE performs a connection release (block 915). The releasing of the RRC connection results in the releasing of resources dedicated to the RRC session. After the RRC connection release, the UE and the source access node are no longer connected.

FIG. 10 illustrates a flow diagram of example operations 1000 occurring in a source access node participating in a direct to indirect handover involving Layer-3 relay UEs.

Operations 1000 begin with the source access node receiving a PDU session release (block 1005). The PDU session release may be received from the AMF, for example. The source access node releases the session release (block 1007). The source access node releases resources dedicated to the RRC session, for example.

FIG. 11 illustrates a flow diagram of example operations 1100 occurring in a relay UE participating in a direct to indirect handover involving Layer-3 relay UEs.

Operations 1100 begin with the relay UE performing relay UE discovery and authorization (block 1105). Relay UE discovery and authorization may include the relay UE making transmissions so that UEs operating in the vicinity can make measurements, for example. Transmissions of UEs that meet a specified signal quality or signal strength threshold may indicate that these UEs may be suitable candidate relay UEs for the UE. The relay UE performs RRC connection establishment (block 1107). The RRC connection establishment process exchanges RRC messages to establish a PC5 connection between the UE and the relay UE.

The relay UE receives the UE to network relay setup request (block 1109). The UE to network relay setup request is received from the UE, for example, and initiates the establishment of a relay connection for the UE and the target access node with the relay UE providing relaying operation. The relay UE relays the UE to network relay setup request (block 1111). The UE to network relay setup request is relayed to the target access node, for example. The information of UE’s direct connection, such as the identity of serving cell/gNB, and the UE’s identity in the serving cell/gNB, is also forwarded to the access and mobility management, session management, and policy control functions (AMF/SMF/PCF 313)

The relay UE receives the UE to network relay setup response (block 1113). The UE to network relay setup response is received from the target access node, for example. The relay UE relays the UE to network relay setup response (block 1115). The UE to network relay setup response is relayed to the UE, for example. The relay UE configures RLC entities of the sidelink bearers. The relay UE receives the UE to network relay setup complete message from the UE (block 1117). After establishing the RLC entities of the sidelink bearers, the UE provides confirmation of the establishment to the relay UE. The UE may also update the RLC configuration of the sidelink bearers. The relay UE sends a remote UE report to the AMF/SMF/PCF (event 1119). The remote UE report indicates to the AMF/SMF/PCF that the UE is now indirectly connected to the target access node.

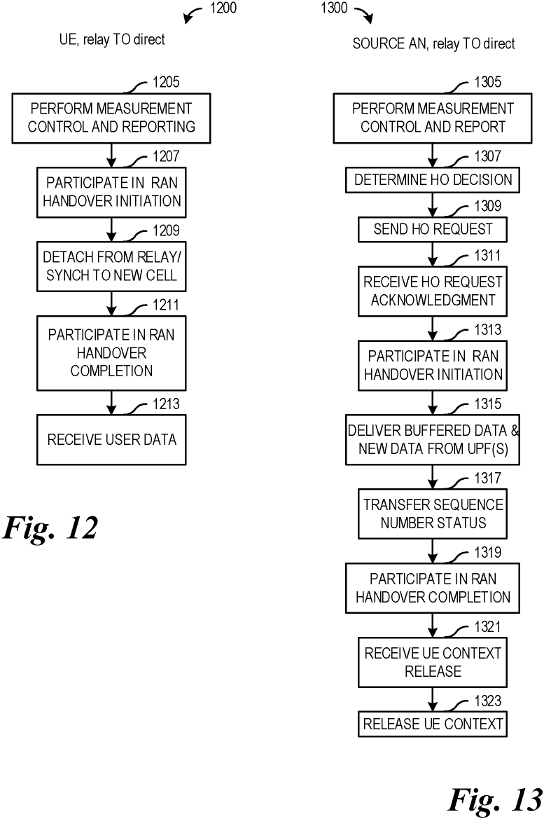

FIG. 12 illustrates a flow diagram of example operations 1200 occurring in a UE participating in an indirect to direct handover involving relay UEs.

Operations 1200 begin with the UE performing measurement control and reporting (block 1205). Measurement control and reporting may be used to determine handoff connections in a network with consideration being given to connection quality and QoS restrictions and requirements. As an example, the UE may provide its measurement report of channel conditions to the source access node, and the source access node may determine if the existing connection is sufficient to meet the QoS restrictions and requirements of the UE. The UE participates in handover initiation (block 1207). Handover initiation may include messages exchanged to start the handover process.

The UE detaches from the relay UE and synchronizes to the target access node (or target cell) (block 1209). Detaching from the relay UE means that the UE is no longer capable of receiving data from the source access node through the relay UE. The UE participates in handover completion (block 1211). Handover completion may include an exchange of messages to complete the completion of the handover, including releasing resources associated with the relay connection through the relay UE, for example.

FIG. 13 illustrates a flow diagram of example operations 1300 occurring in a source access node participating in an indirect to direct handover involving relay UEs.

Operations 1300 begin with the source access node performing measurement control and report (block 1305). Measurement control and report may be used to determine handoff connections in a network with consideration being given to connection quality and QoS restrictions and requirements. As an example, the UE may provide its measurement report of channel conditions to the source access node, and the source access node may determine if the existing connection is sufficient to meet the QoS restrictions and requirements of the UE. The source access node determines a handover decision (block 1307). The source access node may determine if a handover is needed, for example, by comparing a quality measure of a connection between the UE and the target access node to a threshold. Furthermore, if a handover is needed, the source access node selects a target access node for the handover. It may be possible for the source access node and the target access node to be the same.

The source access node sends a handover request (block 1309). The handover request is sent to the target access node, for example. The handover request may include the QoS restrictions and requirements of the UE, as well as identifying information associated with the UE, for example. The source access node receives a handover request acknowledgement (block 1311). The handover request acknowledgement may indicate to the source access node that the target access node is amenable to establishing a connection with the UE. The handover request acknowledgement may also include identifying information of the UE and its configuration of MAC/RLC/PDCP/SDAP entities and DRBs associated with the target access node, for example.

The source access node participates in a handover initiation (block 1313). Handover initiation may include messages exchanged to start the handover process. The source access node also delivers buffered data (along with newly received data from the UPF) to the UE (block 1315). The source access node performs a sequence number status transfer (event 1317). The sequence number status transfer is performed with the target access node and informs the target access node the sequence number of the last packet successfully transmitted to the UE. The transfer of the sequence number helps to ensure that the user data of the UE are not lost or unnecessarily retransmitted.

The source access node participates in handover completion (block 1319). Handover completion may involve exchanging messages to complete the handover, which includes release of resource associated with the UE, for example. The source access node receives a UE context release (block 1321). The UE context release is received from the target access node and is an indication to the source access node that it is ok to release the context of the UE. The source access node releases the context of the UE (block 1323). The source access node 309 sends RRC reconfiguration signaling to the relay UE 307, and changes or removes configurations of RLC channel over PC5 interface (the interface between remote UE 305 and relay UE 307) and Uu interface (the interface between relay UE 307 and target access node 311), and mappings of the remote UE 305 between RLC channels of Uu interface and RLC channels of PC5 interface.

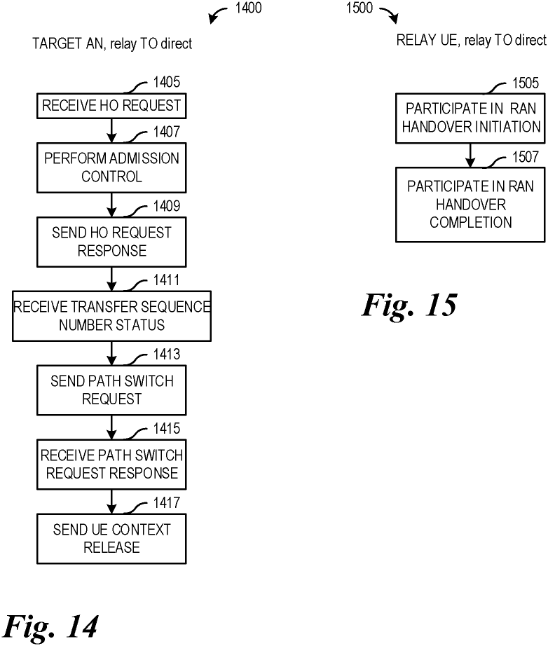

FIG. 14 illustrates a flow diagram of example operations 1400 occurring in a target access node participating in an indirect to direct handover involving relay UEs.

Operations 1400 begin with the target access node receiving a handover request (block 1405). The handover request is received from the source access node, for example, and may include the QoS restrictions and requirements of the UE, as well as identifying information associated with the UE, for example. The target access node performs admission control (block 1407). As an example, the target access node determines if it can support the QoS restrictions and requirements of the UE. The target access node sends a handover request acknowledgement (block 1409). The handover request acknowledgement may indicate to the source access node that the target access node is amenable to establishing a connection with the UE. The handover request acknowledgement may also include identifying information of the UE and its configuration of MAC/RLC/PDCP/SDAP entities and DRBs associated with the target access node, for example.

The target access node receives a transfer of sequence number status (block 1411). The sequence number status transfer is received from source access node and informs the target access node the sequence number of the last packet successfully transmitted to the UE. The target access node sends a path switch request (block 1413). The path switch request is sent to the AMF, for example, and informs the network that the target access node is now the access node for the UE and that the source access node is no longer the access node for the UE. The target access node receives a path switch request acknowledgement (block 1415). The path switch request acknowledgement is received from the AMF. The path switch request acknowledgement indicates to the target access node that the path switch is complete, for example. The target access node sends a UE context release (block 1417). The UE context release is sent to the source access node and indicates to the source access node to release the UE context of the UE, along with resources allocated to the UE (e.g., buffer space, processing resources, etc.).

FIG. 15 illustrates a flow diagram of example operations 1500 occurring in a relay UE participating in an indirect to direct handover involving relay UEs.

Operations 1500 begin with the relay UE participating in a handover initiation (block 1505). The relay UE relays messages exchanged between the UE and the source access node to start the handover process. The relay UE participates in handover completion (block 1507). The relay UE changes or removes configurations of RLC channel over PC5 interface (the interface between remote UE 305 and relay UE 307) and Uu interface (the interface between relay UE 307 and target access node 311), and mappings of the remote UE 305 between RLC channels of Uu interface and RLC channels of PC₅ interface., for example.

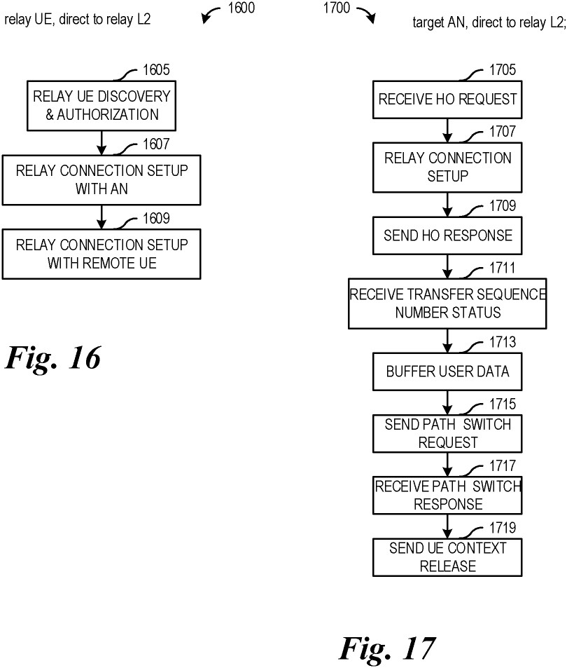

FIG. 16 illustrates a flow diagram of example operations occurring in a relay UE according to example embodiments presented herein. Operations 1600 begin with the communications device performing relay UE discovery and authorization (block 1605). Relay UE discovery and authorization may include relay UE 307 making transmissions on which measurements can be made by UEs operating in the vicinity, for example. Transmissions of UEs that meet a specified signal quality or signal strength threshold may indicate that these UEs may be suitable candidate relay UEs. Relay UE 307 may provide information of its identity and the identity of serving gNB, and the associated mobile network. Remote UE 305 may provide identification information for these UEs to AMF/SMF/PCF 313, which may then perform authorization to determine which of these UEs can serve as relay UEs for remote UE 305.

The relay UE performs relay connection setup with AN (block 1607). The relay UE setup is sent to relay UE 307, for example, and is used to configure relay UE 307. As an example, the relay UE setup is used to configure a radio link control (RLC) channel over PC5 interface, and mappings between RLC channels of Uu interface (the interface between relay UE 307 and target access node 311) and RLC channels of PC5 interface (the interface between remote UE 305 and relay UE 307). The relay UE setup complete is sent to target access node 311, for example, and indicates successful configuration of relay UE 307.

The relay UE performs relay connection setup with remote UE (block 1609). The PC5 connection is setup in accordance with configuration information generated by target access node 311. The RRC Reconfiguration Complete is sent to the relay UE to be forwarded to the target access node 311, for example. The RRC Reconfiguration Complete completes the switching procedure.

FIG. 17 illustrates a flow diagram of example operations occurring in a target access node according to example embodiments presented herein. Operations 1700 begin with the target AN receiving a handover request (block 1705). The communications device performs relay connection setup (block 1707). The relay UE setup is sent to relay UE 307, for example, and is used to configure relay UE 307. As an example, the relay UE setup is used to configure a radio link control (RLC) channel over PC₅ interface, and mappings between RLC channels of Uu interface (the interface between relay UE 307 and target access node 311) and RLC channels of PC5 interface (the interface between remote UE 305 and relay UE 307). The relay UE setup complete is received by target access node 311, for example, and indicates successful configuration of relay UE 307. The target access node sends a handover response (block 1709). The target access node receives a transfer sequence number status (block 1711). The target access node buffers user data (block 1713). The target access node sends a path switch request (block 1715). The target access node receives a path switch response (block 1717). The target access node sends a UE context release (block 1719).

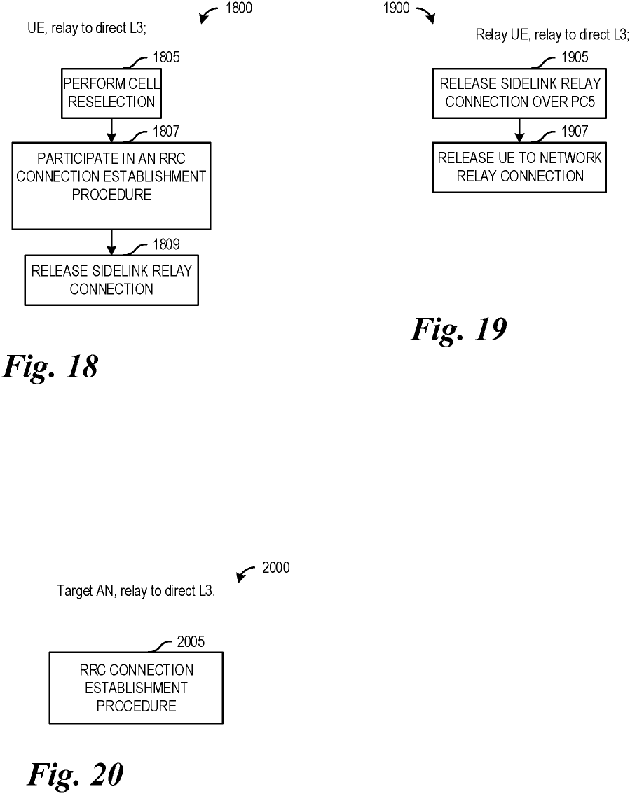

FIG. 18 illustrates a flow diagram of example operations occurring in a communications device as a remote UE according to example embodiments presented herein. Operations 1800 begin with the communications device performing cell reselection (block 1805). The communications device then participates in an RRC connection establishment procedure (block 1807). The procedures may include a random access procedure, a RRC connection establishment procedure, a service request, and a PDU session establishment procedure. After completion of the procedures to establish service with target access node 311, remote UE 305 is connected to target access node 311 with a PDU session. The remote UE 305 should also indicate that it has an indirect connection with the network, through a relay UE, and provides the information about the indirect connection, such as the identity information of the relay UE and its serving gNB, the UE identity used in the indirect connection, the IP address/prefix or TCP/UDP port number used in the indirect connection, MAC address used in the indirect connection, PC₅ link identity used in the indirect connection, PDU session identity used in the indirect connection, etc. The communications device thereafter releases a sidelink relay connection (block 1809). Remote UE 305 releases the RLC channels on sidelink connection for UE to network relay. Remote UE 305 is no longer connected to source access node 309 through relay UE 307.

FIG. 19 illustrates a flow diagram of example operations occurring in a communications device as a relay UE according to example embodiments presented herein. Operations 1900 begin with the communications device releasing RLC channels for a sidelink relay connection over PC5 (block 1905). Remote UE 305 and relay UE 307 release the RLC channels on sidelink connection for UE to network relay. Remote UE 305 is no longer connected to source access node 309 through relay UE 307. The communications device then releases a UE to network connection (block 1907). The relay UE receives the UE to network relay release from source access node 309, which transfers the UE to network relay release from AMF/SMF/PCF to relay UE 307. The relay UE can be provided with the UE’s information, such as the UE identity used in the indirect connection, the IP address/prefix or TCP/UDP port number used in the indirect connection, MAC address used in the indirect connection, PC5 link identity used in the indirect connection, PDU session identity used in the indirect connection, etc. Relay UE 307 stops serving remote UE 305 (block 517).

FIG. 20 illustrates a flow diagram of example operations occurring in a communications device as target access node according to example embodiments presented herein, which includes the device participating in a RRC connection establishment procedure (2005). The procedures may include a random access procedure, a RRC connection establishment procedure, a service request, and a PDU session establishment procedure. After completion of the procedures to establish RRC connection with a remote UE 305, remote UE 305 is connected to target access node 311 with a PDU session. The target access node also forwards message from the remote UE 305 indicating that it has an indirect connection with the network, through a relay UE, and providing the information about the indirect connection, such as the identity information of the relay UE and the source access node 309, the UE identity used in the indirect connection, the IP address/prefix or TCP/UDP port number used in the indirect connection, MAC address used in the indirect connection, PC₅ link identity used in the indirect connection, PDU session identity used in the indirect connection, etc.

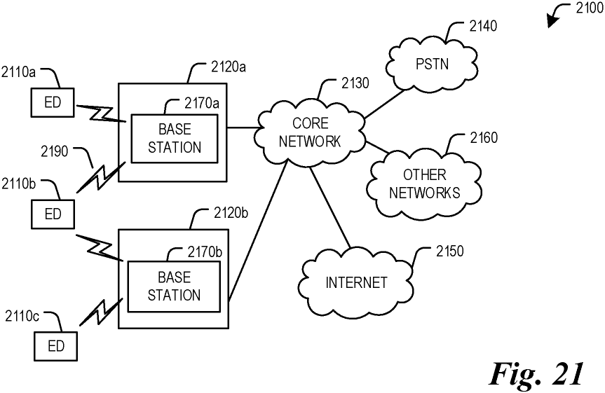

FIG. 21 illustrates an example communication system 2100. In general, the system 2100 enables multiple wireless or wired users to transmit and receive data and other content. The system 2100 may implement one or more channel access methods, such as code division multiple access (CDMA), time division multiple access (TDMA), frequency division multiple access (FDMA), orthogonal FDMA (OFDMA), single-carrier FDMA (SC-FDMA), or non-orthogonal multiple access (NOMA).

In this example, the communication system 2100 includes electronic devices (ED) 2110a-2110c, radio access networks (RANs) 2120a-2120b, a core network 2130, a public switched telephone network (PSTN) 2140, the Internet 2150, and other networks 2160. While certain numbers of these components or elements are shown in FIG. 21, any number of these components or elements may be included in the system 2100.

The EDs 2110a-2110c are configured to operate or communicate in the system 2100. For example, the EDs 2110a-2110c are configured to transmit or receive via wireless or wired communication channels. Each ED 2110a-2110c represents any suitable end user device and may include such devices (or may be referred to) as a user equipment or device (UE), wireless transmit or receive unit (WTRU), mobile station, fixed or mobile subscriber unit, cellular telephone, personal digital assistant (PDA), smartphone, laptop, computer, touchpad, wireless sensor, or consumer electronics device.

The RANs 2120a-2120b here include base stations 2170a-2170b, respectively. Each base station 2170a-2170b is configured to wirelessly interface with one or more of the EDs 2110a-2110c to enable access to the core network 2130, the PSTN 2140, the Internet 2150, or the other networks 2160. For example, the base stations 2170a-2170b may include (or be) one or more of several well-known devices, such as a base transceiver station (BTS), a Node-B (NodeB), an evolved NodeB (eNodeB), a Next Generation (NG) NodeB (gNB), a Home NodeB, a Home eNodeB, a site controller, an access point (AP), or a wireless router. The EDs 2110a-2110c are configured to interface and communicate with the Internet 2150 and may access the core network 2130, the PSTN 2140, or the other networks 2160.

In the embodiment shown in FIG. 21, the base station 2170a forms part of the RAN 2120a, which may include other base stations, elements, or devices. Also, the base station 2170b forms part of the RAN 2120b, which may include other base stations, elements, or devices. Each base station 2170a-2170b operates to transmit or receive wireless signals within a particular geographic region or area, sometimes referred to as a “cell.” In some embodiments, multiple-input multiple-output (MIMO) technology may be employed having multiple transceivers for each cell.

The base stations 2170a-2170b communicate with one or more of the EDs 2110a-2110c over one or more air interfaces 2190 using wireless communication links. The air interfaces 2190 may utilize any suitable radio access technology.

It is contemplated that the system 2100 may use multiple channel access functionality, including such schemes as described above. In particular embodiments, the base stations and EDs implement 5G New Radio (NR), LTE, LTE-A, or LTE-B. Of course, other multiple access schemes and wireless protocols may be utilized.

The RANs 2120a-2120b are in communication with the core network 2130 to provide the EDs 2110a-2110c with voice, data, application, Voice over Internet Protocol (VoIP), or other services. Understandably, the RANs 2120a-2120b or the core network 2130 may be in direct or indirect communication with one or more other RANs (not shown). The core network 2130 may also serve as a gateway access for other networks (such as the PSTN 2140, the Internet 2150, and the other networks 2160). In addition, some or all of the EDs 2110a-2110c may include functionality for communicating with different wireless networks over different wireless links using different wireless technologies or protocols. Instead of wireless communication (or in addition thereto), the EDs may communicate via wired communication channels to a service provider or switch (not shown), and to the Internet 2150.

Although FIG. 21 illustrates one example of a communication system, various changes may be made to FIG. 21. For example, the communication system 2100 could include any number of EDs, base stations, networks, or other components in any suitable configuration.

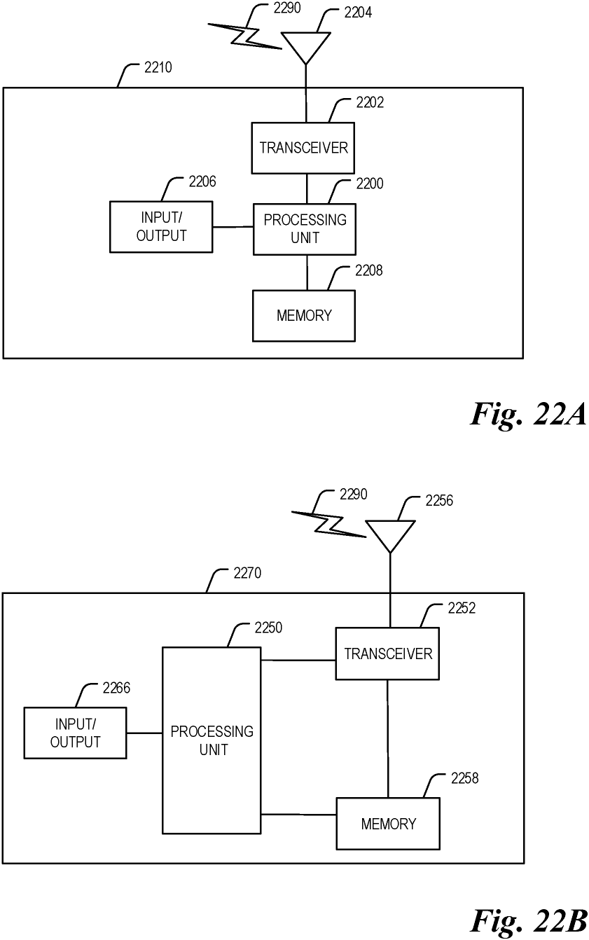

FIGS. 22A and 22B illustrate example devices that may implement the methods and teachings according to this disclosure. In particular, FIG. 22A illustrates an example ED 2210, and FIG. 22B illustrates an example base station 2270. These components could be used in the system 2100 or in any other suitable system.

As shown in FIG. 22A, the ED 2210 includes at least one processing unit 2200. The processing unit 2200 implements various processing operations of the ED 2210. For example, the processing unit 2200 could perform signal coding, data processing, power control, input/output processing, or any other functionality enabling the ED 2210 to operate in the system 2100. The processing unit 2200 also supports the methods and teachings described in more detail above. Each processing unit 2200 includes any suitable processing or computing device configured to perform one or more operations. Each processing unit 2200 could, for example, include a microprocessor, microcontroller, digital signal processor, field programmable gate array, or application specific integrated circuit.

The ED 2210 also includes at least one transceiver 2202. The transceiver 2202 is configured to modulate data or other content for transmission by at least one antenna or NIC (Network Interface Controller) 2204. The transceiver 2202 is also configured to demodulate data or other content received by the at least one antenna 2204. Each transceiver 2202 includes any suitable structure for generating signals for wireless or wired transmission or processing signals received wirelessly or by wire. Each antenna 2204 includes any suitable structure for transmitting or receiving wireless or wired signals. One or multiple transceivers 2202 could be used in the ED 2210, and one or multiple antennas 2204 could be used in the ED 2210. Although shown as a single functional unit, a transceiver 2202 could also be implemented using at least one transmitter and at least one separate receiver.

The ED 2210 further includes one or more input/output devices 2206 or interfaces (such as a wired interface to the Internet 2150). The input/output devices 2206 facilitate interaction with a user or other devices (network communications) in the network. Each input/output device 2206 includes any suitable structure for providing information to or receiving information from a user, such as a speaker, microphone, keypad, keyboard, display, or touch screen, including network interface communications.

In addition, the ED 2210 includes at least one memory 2208. The memory 2208 stores instructions and data used, generated, or collected by the ED 2210. For example, the memory 2208 could store software or firmware instructions executed by the processing unit(s) 2200 and data used to reduce or eliminate interference in incoming signals. Each memory 2208 includes any suitable volatile or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 22B, the base station 2270 includes at least one processing unit 2250, at least one transceiver 2252, which includes functionality for a transmitter and a receiver, one or more antennas 2256, at least one memory 2258, and one or more input/output devices or interfaces 2266. A scheduler, which would be understood by one skilled in the art, is coupled to the processing unit 2250. The scheduler could be included within or operated separately from the base station 2270. The processing unit 2250 implements various processing operations of the base station 2270, such as signal coding, data processing, power control, input/output processing, or any other functionality. The processing unit 2250 can also support the methods and teachings described in more detail above. Each processing unit 2250 includes any suitable processing or computing device configured to perform one or more operations. Each processing unit 2250 could, for example, include a microprocessor, microcontroller, digital signal processor, field programmable gate array, or application specific integrated circuit.

Each transceiver 2252 includes any suitable structure for generating signals for wireless or wired transmission to one or more EDs or other devices. Each transceiver 2252 further includes any suitable structure for processing signals received wirelessly or by wire from one or more EDs or other devices. Although shown combined as a transceiver 2252, a transmitter and a receiver could be separate components. Each antenna 2256 includes any suitable structure for transmitting or receiving wireless or wired signals. While a common antenna 2256 is shown here as being coupled to the transceiver 2252, one or more antennas 2256 could be coupled to the transceiver(s) 2252, allowing separate antennas 2256 to be coupled to the transmitter and the receiver if equipped as separate components. Each memory 2258 includes any suitable volatile or non-volatile storage and retrieval device(s). Each input/output device 2266 facilitates interaction with a user or other devices (network communications) in the network. Each input/output device 2266 includes any suitable structure for providing information to or receiving/providing information from a user, including network interface communications.

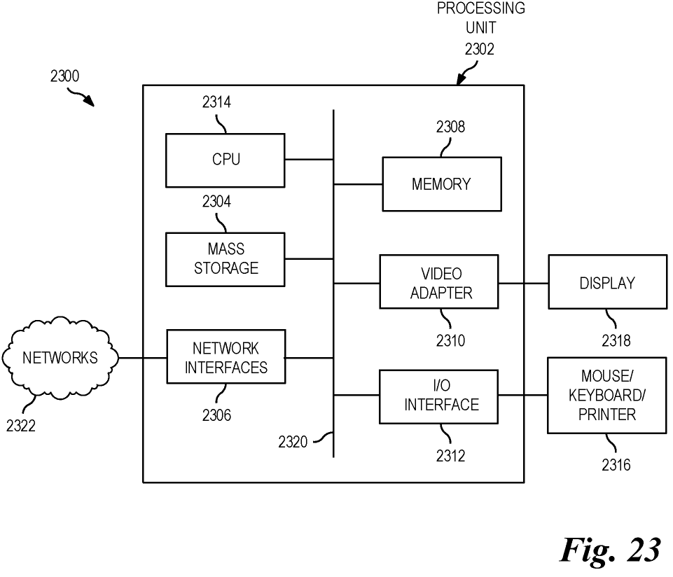

FIG. 23 is a block diagram of a computing system 2300 that may be used for implementing the devices and methods disclosed herein. For example, the computing system can be any entity of UE, access network (AN), mobility management (MM), session management (SM), user plane gateway (UPGW), or access stratum (AS). Specific devices may utilize all of the components shown or only a subset of the components, and levels of integration may vary from device to device. Furthermore, a device may contain multiple instances of a component, such as multiple processing units, processors, memories, transmitters, receivers, etc. The computing system 2300 includes a processing unit 2302. The processing unit includes a central processing unit (CPU) 2314, memory 2308, and may further include a mass storage device 2304, a video adapter 2310, and an I/O interface 2312 connected to a bus 2320.

The bus 2320 may be one or more of any type of several bus architectures including a memory bus or memory controller, a peripheral bus, or a video bus. The CPU 2314 may comprise any type of electronic data processor. The memory 2308 may comprise any type of non-transitory system memory such as static random access memory (SRAM), dynamic random access memory (DRAM), synchronous DRAM (SDRAM), read-only memory (ROM), or a combination thereof. In an embodiment, the memory 2308 may include ROM for use at boot-up, and DRAM for program and data storage for use while executing programs.

The mass storage 2304 may comprise any type of non-transitory storage device configured to store data, programs, and other information and to make the data, programs, and other information accessible via the bus 2320. The mass storage 2304 may comprise, for example, one or more of a solid state drive, hard disk drive, a magnetic disk drive, or an optical disk drive.

The video adapter 2310 and the I/O interface 2312 provide interfaces to couple external input and output devices to the processing unit 2302. As illustrated, examples of input and output devices include a display 2318 coupled to the video adapter 2310 and a mouse, keyboard, or printer 2316 coupled to the I/O interface 2312. Other devices may be coupled to the processing unit 2302, and additional or fewer interface cards may be utilized. For example, a serial interface such as Universal Serial Bus (USB) (not shown) may be used to provide an interface for an external device.

The processing unit 2302 also includes one or more network interfaces 2306, which may comprise wired links, such as an Ethernet cable, or wireless links to access nodes or different networks. The network interfaces 2306 allow the processing unit 2302 to communicate with remote units via the networks. For example, the network interfaces 2306 may provide wireless communication via one or more transmitters/transmit antennas and one or more receivers/receive antennas. In an embodiment, the processing unit 2302 is coupled to a local-area network 2322 or a wide-area network for data processing and communications with remote devices, such as other processing units, the Internet, or remote storage facilities.

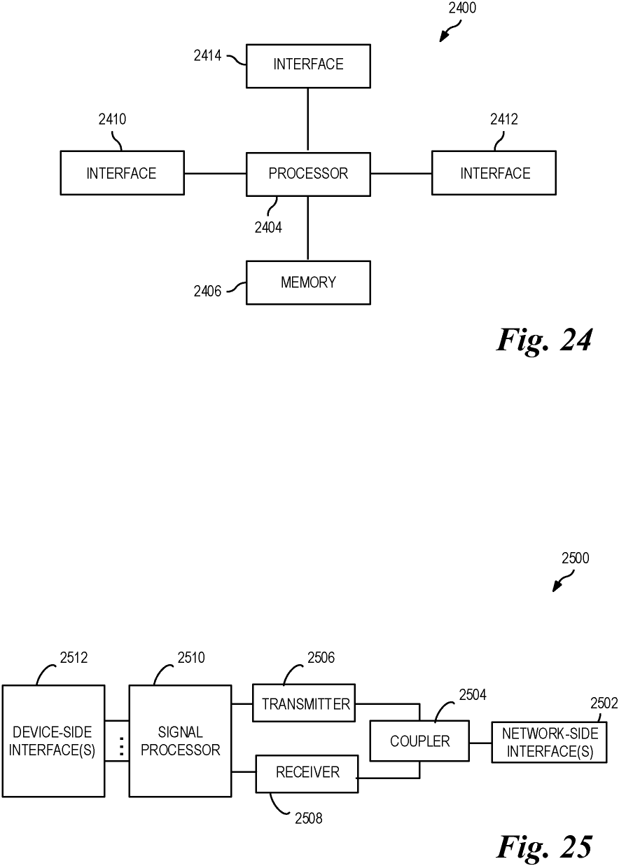

FIG. 24 illustrates a block diagram of an embodiment processing system 2400 for performing methods described herein, which may be installed in a host device. As shown, the processing system 2400 includes a processor 2404, a memory 2406, and interfaces 2410-2414, which may (or may not) be arranged as shown in FIG. 24. The processor 2404 may be any component or collection of components adapted to perform computations and/or other processing related tasks, and the memory 2406 may be any component or collection of components adapted to store programming and/or instructions for execution by the processor 2404. In an embodiment, the memory 2406 includes a non-transitory computer readable medium. The interfaces 2410, 2412, 2414 may be any component or collection of components that allow the processing system 2400 to communicate with other devices/components and/or a user. For example, one or more of the interfaces 2410, 2412, 2414 may be adapted to communicate data, control, or management messages from the processor 2404 to applications installed on the host device and/or a remote device. As another example, one or more of the interfaces 2410, 2412, 2414 may be adapted to allow a user or user device (e.g., personal computer (PC), etc.) to interact/communicate with the processing system 2400. The processing system 2400 may include additional components not depicted in FIG. 24, such as long term storage (e.g., non-volatile memory, etc.).

In some embodiments, the processing system 2400 is included in a network device that is accessing, or part otherwise of, a telecommunications network. In one example, the processing system 2400 is in a network-side device in a wireless or wireline telecommunications network, such as a base station, a relay station, a scheduler, a controller, a gateway, a router, an applications server, or any other device in the telecommunications network. In other embodiments, the processing system 2400 is in a user-side device accessing a wireless or wireline telecommunications network, such as a mobile station, a user equipment (UE), a personal computer (PC), a tablet, a wearable communications device (e.g., a smartwatch, etc.), or any other device adapted to access a telecommunications network.

In some embodiments, one or more of the interfaces 2410, 2412, 2414 connects the processing system 2400 to a transceiver adapted to transmit and receive signaling over the telecommunications network. FIG. 25 illustrates a block diagram of a transceiver 2500 adapted to transmit and receive signaling over a telecommunications network. The transceiver 2500 may be installed in a host device. As shown, the transceiver 2500 comprises a network-side interface 2502, a coupler 2504, a transmitter 2506, a receiver 2508, a signal processor 2510, and a device-side interface 2512. The network-side interface 2502 may include any component or collection of components adapted to transmit or receive signaling over a wireless or wireline telecommunications network. The coupler 2504 may include any component or collection of components adapted to facilitate bi-directional communication over the network-side interface 2502. The transmitter 2506 may include any component or collection of components (e.g., up-converter, power amplifier, etc.) adapted to convert a baseband signal into a modulated carrier signal suitable for transmission over the network-side interface 2502. The receiver 2508 may include any component or collection of components (e.g., down-converter, low noise amplifier, etc.) adapted to convert a carrier signal received over the network-side interface 2502 into a baseband signal. The signal processor 2510 may include any component or collection of components adapted to convert a baseband signal into a data signal suitable for communication over the device-side interface(s) 2512, or vice-versa. The device-side interface(s) 2512 may include any component or collection of components adapted to communicate data-signals between the signal processor 2510 and components within the host device (e.g., the processing system 2400, local area network (LAN) ports, etc.).

The transceiver 2500 may transmit and receive signaling over any type of communications medium. In some embodiments, the transceiver 2500 transmits and receives signaling over a wireless medium. For example, the transceiver 2500 may be a wireless transceiver adapted to communicate in accordance with a wireless telecommunications protocol, such as a cellular protocol (e.g., long-term evolution (LTE), etc.), a wireless local area network (WLAN) protocol (e.g., Wi-Fi, etc.), or any other type of wireless protocol (e.g., Bluetooth, near field communication (NFC), etc.). In such embodiments, the network-side interface 2502 comprises one or more antenna/radiating elements. For example, the network-side interface 2502 may include a single antenna, multiple separate antennas, or a multi-antenna array configured for multi-layer communication, e.g., single input multiple output (SIMO), multiple input single output (MISO), multiple input multiple output (MIMO), etc. In other embodiments, the transceiver 2500 transmits and receives signaling over a wireline medium, e.g., twisted-pair cable, coaxial cable, optical fiber, etc. Specific processing systems and/or transceivers may utilize all of the components shown, or only a subset of the components, and levels of integration may vary from device to device.

It should be appreciated that one or more steps of the embodiment methods provided herein may be performed by corresponding circuits, units, or modules. For example, a signal may be transmitted by a transmitting circuit, unit, or module. A signal may be received by a receiving circuit, unit, or module. A signal may be processed by a processing circuit, unit, or module. Other steps may be performed by a participating circuit, unit, or module. The respective circuits, units, or modules may be hardware, software, or a combination thereof. For instance, one or more of the circuits, units, or modules may be an integrated circuit, such as field programmable gate arrays (FPGAs) or application-specific integrated circuits (ASICs).

Although the present disclosure and its advantages have been described in detail, it should be understood that various changes, substitutions and alterations can be made herein without departing from the scope of the disclosure as defined by the appended claims.

What is claimed is:

1. A method comprising:
sending, by a user equipment (UE) to a source access node, a message including a relay UE information report comprising information associated with at least one UE detectable by the UE;
participating, by the UE with the source access node, in a handover initiation;
detaching, by the UE, from the source access node;
synchronizing, by the UE, with the at least one UE, the at least one UE operating as a relay UE for communication between the UE and a target access node over a sidelink connection; and
participating, by the UE with the at least one UE, in a handover completion.

2. The method of claim 1, the relay UE information report comprising at least one of UE identity information of the at least one UE, measurements of at least one connection between the UE and the at least one UE, or cell identity information of cells of the at least one UE.

3. The method of claim 1, the message being sent over a Uu interface.

4. The method of claim 1, further comprising:
performing, by the UE, relay UE discovery and authorization.

5. The method of claim 1, the participating in the handover initiation comprising:
receiving, by the UE from the source access node, UE identity information of the at least one UE.

6. The method of claim 5, the participating in the handover initiation comprising:
receiving first cell identity information of a cell of the at least one UE.

7. The method of claim 6, the participating in the handover completion comprising:
setting up, by the UE with the at least one UE, the sidelink connection; and
sending, by the UE to the cell of the at least one UE, a reconfiguration complete message.

8. The method of any one of claim 6, the cell and the source access node being the same.

9. A method comprising:
receiving, by a source access node from a user equipment (UE), a message including a relay UE information report comprising information associated with at least one UE detectable by the UE;
determining, by the source access node, to perform a handover in accordance with the relay UE information report, the determining to perform the handover comprising:
selecting the at least one UE to relay communication between the UE and a target access node over a sidelink connection;
initiating, by the source access node to a serving cell of the at least one UE, the handover; and
releasing, by the source access node, a UE context of the UE.

10. The method of claim 9, the relay UE information report comprising at least one of UE identity information of the at least one UE, measurements of at least one connection between the UE and the at least one UE, or cell identity information of cells of the at least one UE.

11. The method of claim 9, the initiating the handover comprising:
sending, by the source access node to the serving cell, a handover request including UE identity information of the at least one UE.

12. The method of claim 11, the initiating the handover comprising:
receiving, by the source access node from the serving cell, a handover request acknowledgement.

13. The method of claim 9, further comprising:
participating, by the source access node with the UE, in a handover initiation.

14. The method of claim 13, the participating in the handover initiation comprising:
sending, from the source access node to the UE, UE identity information of the at least one UE.

15. The method of claim 9, further comprising:
transferring, by the source access node to the serving cell, sequence number status.

16. The method of claim 9, further comprising:
sending, by the source access node to the serving cell, an end marker.

17. The method of claim 9, the source access node and the serving cell being the same.

18. A user equipment (UE) comprising:
one or more processors; and
a non-transitory memory storage comprising instructions that, when executed by the one or more processors, cause the UE to perform operations including:
sending, to a source access node, a message including a relay UE information report comprising information associated with at least one UE detectable by the UE;
participating, with the source access node, in a handover initiation;
detaching from the source access node;
synchronizing with the at least one UE, the at least one UE operating as a relay UE for communication between the UE and a target access node over a sidelink connection; and
participating, with the at least one UE, in a handover completion.

19. The UE of claim 18, the relay UE information report comprising at least one of UE identity information of the at least one UE, measurements of at least one connection between the UE and the at least one UE, or cell identity information of cells of the at least one UE.

20. The UE of claim 18, the message being sent over a Uu interface.

21. The UE of claim 18, the operations further comprising:
performing relay UE discovery and authorization.

22. The UE of claim 18, the participating in the handover initiation comprising:
receiving, by the UE from the source access node, UE identity information of the at least one UE.

23. The UE of claim 22, the participating in the handover initiation comprising:
receiving first cell identity information of a cell of the at least one UE.

24. The UE of claim 23, the participating in the handover completion comprising:
setting up, with the at least one UE, the sidelink connection; and
sending, to the cell of the at least one UE, a reconfiguration complete message.

25. An access node comprising:
one or more processors; and
a non-transitory memory storage comprising instructions that, when executed by the one or more processors, cause the access node to cause the access node to perform operations including:
receiving, from a user equipment (UE), a message including a relay UE information report comprising information associated with at least one UE detectable by the UE;
determining to perform a handover in accordance with the relay UE information report, the determining to perform the handover comprising:
selecting the at least one UE to relay communication between the UE and a target access node over a sidelink connection;
initiating, to a serving cell of the at least one UE, the handover; and
releasing a UE context of the UE.

26. The access node of claim 25, the relay UE information report comprising at least one of UE identity information of the at least one UE, measurements of at least one connection between the UE and the at least one UE, or cell identity information of cells of the at least one UE.

27. The access node of claim 25, the initiating the handover comprising:
sending, to the serving cell, a handover request including UE identity information of the at least one UE.

28. The access node of claim 27, the initiating the handover comprising:
receiving, from the serving cell, a handover request acknowledgement.

29. The access node of claim 25, the operations further comprising:
participating, with the UE, in a handover initiation.

30. The access node of claim 29, the participating in the handover initiation comprising:
sending, to the UE, UE identity information of the at least one UE.

31. The access node of claim 25, the operations further comprising:
transferring, to the serving cell, sequence number status.

32. The access node of claim 25, further comprising:
sending, to the serving cell, an end marker.
